(19) United States
(12) Patent Application Publication
(10) Pub. No.: US 2021/0256435 A1
(43) Pub. Date: Aug. 19, 2021

(54) System and Method for Sales Multi-threading Recommendations

(71) Applicant: Introhive Services Inc., Fredericton (CA)

(72) Inventors: Amy PALMER, Fredericton (CA); David HUDSON, Fredericton (CA)

(21) Appl. No.: 17/179,358

(22) Filed: Feb. 18, 2021

Related U.S. Application Data
(60) Provisional application No. 62/977,934, filed on Feb. 18, 2020.

(51) Int. Cl. G06Q 10/06; G06Q 30/00

(52) U.S. Cl. CPC G06Q 10/0633; G06Q 30/01; G06Q 10/06393

(57) ABSTRACT

Method for analyzing data in respect of one or more opportunities, comprising: receiving, from one or more storage devices: (A) account team member data that: (i) identifies a group of contacts that have been identified as participating in a target opportunity; and (B) enterprise team member data that: identifies a group of users that have been identified as participating in the target opportunity. The account team member data and the enterprise team member data is processed using a predefined model to assign a current multi-thread score to the target opportunity, the current multi-thread score being indicative of a suitability of the combined membership of the group of contacts and the group of users.

### CROSS-REFERENCE TO RELATED APPLICATIONS

This application claims the benefit of and priority to U.S. Provisional Patent Application No. 62/977,934, filed Feb. 18, 2020, the content of which is incorporated herein by reference.

### TECHNICAL FIELD

The present disclosure relates to automated systems and methods for data analysis of sales data acquired from multiple sources for recommending actions to enable a multi-threaded sales approach.

### BACKGROUND

Enterprises such as companies, accounting firms, law firms, universities, partnerships, agencies and governments commonly use Customer Relationship Management (CRM) technology to manage relationships and interactions with other parties such as customers and potential customers.

In particular, CRM systems typically employ electronic computing and communications devices that enable one or more of contact management, sales management, and calendar management with the objective of enhancing productivity. An important function provided by CRM systems is digital tracking and storage of data about third parties such as customers and potential customers.

One of the growing trends in today's business to business deals is to apply a multi-threaded sales approach. Multi-threaded sales are deals that involve multiple decision makers on the purchasing side and multiple people on the selling side. There is a recognized advantage to a multi-pronged approach involving more customer stakeholders, including for example having multiple points of contact can mitigate against the departure of individuals from either the purchasing team or the selling team. Multi-threading sales practices focus a sales team on making connections with multiple decision-makers on the purchasing side.

One of the problems that remains is that of identifying and taking advantage of existing relationships to build these connections. It can take a significant investment of time to obtain introductions and to grow a new relationship with a contact at an account, and the time required may not align with an opportunity that the sales team is pursuing.

Accordingly, there is a need for automated systems and methods that recommend an action to a sales team that optimizes the use of resources.

### SUMMARY

According to an example aspect is a computer implemented method and system for analyzing data in respect of one or more opportunities that exist between an enterprise entity that has a plurality of associated users and an account entity that has a plurality of associated contacts, the method comprising: receiving, from one or more electronic storage devices: (A) account team member data that: (i) identifies a group of contacts that have been identified as participating in a target opportunity; (ii) includes title scores for at least some of the contacts included in the group of contacts, the title sore for each contact being indicative of a position of the contact in a hierarchy of the account entity; (iii) includes department indicators for at least some of the contacts included in the group of contacts, wherein the department indicator for each contact indicates a department of the account entity that the contact is a member of; and (iv) relationship scores for at least some of the contacts included in the group of contacts, the relationship score for each contact indicating a strength of a relationship between the contact and the enterprise entity; and (B) enterprise team member data that: identifies a group of users that have been identified as participating in the target opportunity. The account team member data and the enterprise team member data is processed using a predefined model to assign a current multi-thread score to the target opportunity, the current multi-thread score being indicative of a suitability of the combined membership of the group of contacts and the group of users.

### BRIEF DESCRIPTION OF THE DRAWINGS

Exemplary embodiments are illustrated in the referenced figures of the drawings. It is intended that the embodiments and figures disclosed herein are to be considered illustrative rather than restrictive.

FIG. 1 is a simplified block diagram illustrating multi-threading computing environment that includes an enterprise network, a multi-threading module, a CRM system and a CRM support system in accordance with example embodiments of the present disclosure.

FIG. 2 is a block diagram of the pattern generation model of the multi-threading module, which is used to generate opportunity patterns according to example embodiments.

FIG. 3 illustrates steps taken by the pattern generation model to generate opportunity features.

FIG. 4 illustrates steps taken by the multi-threading module to generate a recommendation according to example embodiments.

FIG. 5 illustrates steps taken by the multi-threading module, according to further example embodiments, to generate a recommendation according to example embodiments.

FIG. 6 illustrates a block diagram of a computer system that can be configured to implement one or more processes and features of the methods and systems described.

Similar reference numerals may have been used in different figures to denote similar components.

### DESCRIPTION

Example embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Example embodiments described herein are directed to computer implemented systems and methods for determining a recommendation of an action to improve a multi-threaded approach of a sales opportunity. The determination of an action to improve multi-threading can be based on information from several sources about the current opportunity, as well as historic information compiled from several sources for past opportunities.

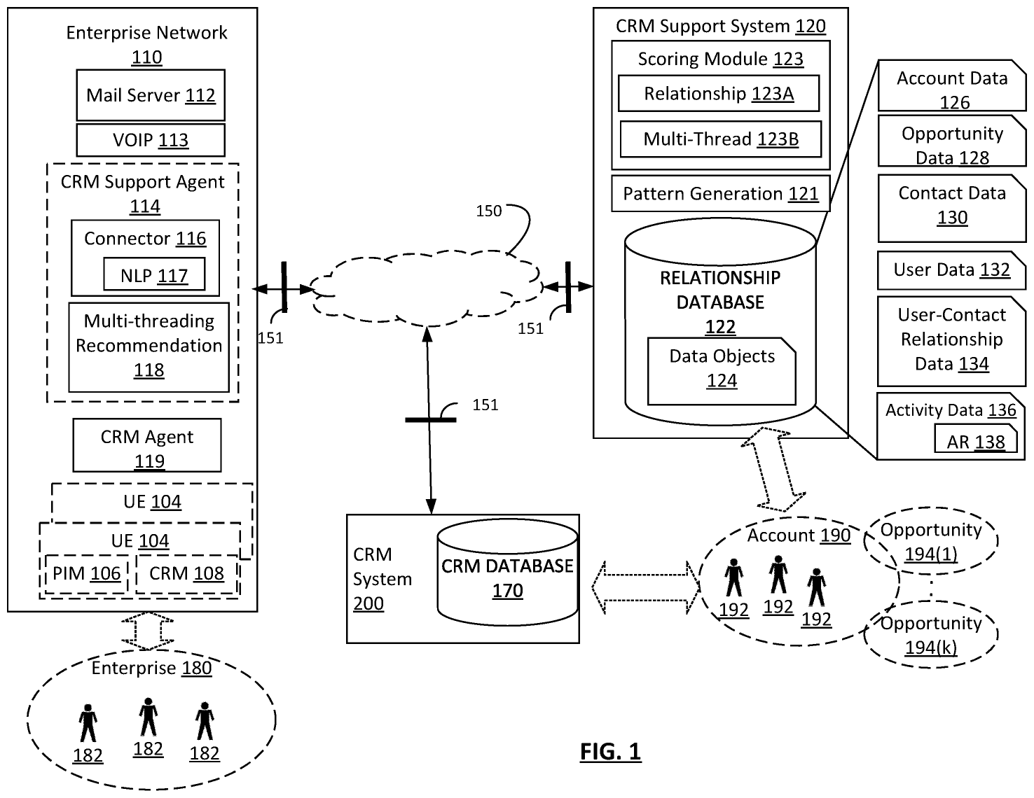

FIG. 1 illustrates an example environment in which the methods and systems described in this disclosure may be implemented. In the example of FIG. 1, environment includes an enterprise network 110 that supports an enterprise such as a company, firm or other type of organization (referred to in this disclosure as “enterprise 180”) that is selling or otherwise providing a product or service. Accordingly, as used here, “enterprise” can refer to the selling entity in a transaction or deal. In example embodiments, a plurality of individuals are registered or otherwise associated with the enterprise network 110 as users 182 of the enterprise 180. These individual users 182 may for example be employees, owners, partners, consultants, volunteers, and interns of the enterprise 180. In some examples, enterprise 180 could have as few as one user 182, and in some examples, enterprise 180 may have thousands or more users 182.

At any given time, the enterprise 180 has, or is, pursuing commercial relationships with one or more external entities or third party organizations, referred to in this disclosure as “accounts” 190. For example, such external entities could be existing or potential customers, clients or donors or other entities of interest to the enterprise, and may include, among other things, companies, partnerships, universities, firms, government entities, joint venture groups, non-government organizations, charities and other types of groups. Accordingly, as used here, “account” can refer to the purchasing entity in a transaction or deal. Typically, each account 190 will have an associated set of individual representatives or contacts, referred to in this disclosure as “contacts” 192, that are identified as contacts of the enterprise 180 in one or more electronic databases that are operated by or associated with enterprise 180. For example, the individual contacts 192 associated with an account 190 may be employees, owners, partners, consultants, volunteers, and interns of the account 190. Furthermore, at any given time the enterprise 180 will typically have completed or will be pursuing one or more opportunities 194(1) to 194(k) with account 190 (with k being account dependent and representing a total number of open and closed opportunities with a specific account 190). In this disclosure, the reference “opportunity 194(j)” will be used to refer a generic individual opportunity with an account 190, and “opportunities 194” used to refer to a generic group of opportunities with all accounts 190. An opportunity 194(j) may for example be a sales opportunity to sell a product or service, and may have an opportunity lifetime (e.g., duration of time from recognition of existence of the opportunity to closing of the opportunity) that can be divided into a set of successive stages or phases such as the basic stages of a sales cycle (e.g., (i) find leads (prospecting), (ii) connect, (iii) qualify leads, (iv) present, (v) overcome objections and (vi) close).

Enterprise network 110 may, for example, include a plurality of computer devices, servers and computer systems that are associated with the enterprise 180 and are linked to each other through one or more internal or external communication networks, at least some of which may implement one or more virtual private networks (VPN).

In example embodiments, the environment of FIG. 1 also includes a CRM support system 120, and a CRM system 200, each of which may also include one or more computer devices, servers and network systems. One or more of CRM support system 120 and CRM system 200 may, in some examples, be operated by third party organizations that are service providers to the enterprise 180 associated with enterprise network 110. CRM support system 120 and a CRM system 200 are configured to track customer data (e.g., data pertaining to one or more accounts) on behalf of enterprise 180.

In the illustrated example, enterprise network 110, CRM support system 120, and CRM system 200 are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 110, CRM support system 120, and CRM system 200. In different example embodiments, one or more of the features, modules or functions of enterprise network 110, CRM support system 120, and CRM system 200 that are described herein could alternatively be implemented in common systems or systems within a common network. For example, some or all of the features or modules of one or both of CRM support system 120 and CRM system 200 could alternatively be hosted on one or more computer systems located within the enterprise network 110. Alternatively, in some examples, some or all or the agents, modules or systems included in FIG. 1 as part of enterprise network 110 could be remotely hosted (for example at CRM support system 120 or CRM system 200) and accessed by users 182 of the enterprise network 110 through network 150. The locations of various modules, engines, systems and databases as shown in FIG. 1 is illustrative of only one of many possible architecture configurations.

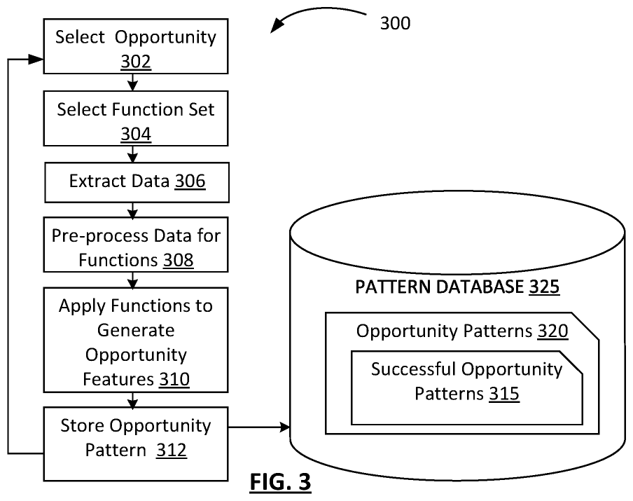

As used here, a “module” or “engine” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit. For example, a hardware processing circuit can include components of a computer system 2010 as described below in in respect of FIG. 3. A database or data storage can refer to a collection of information that is stored in an electronically accessible format using a non-transitory storage medium.

Enterprise Network 110

Enterprise network 110 includes at least one mail server 112 for handling and delivering external email that enterprise network 110 exchanges with remote mail servers through communication network 150. Thus, mail server 112 contains emails sent/received by the enterprise associated with enterprise network 110. In some examples, mail server 112 may also handle internal emails that are internal within the enterprise network 110.

In some examples, Enterprise network 110 includes at least one voice over internet protocol (VOIP) system 113 handling internal and external telephone communications. VOIP system 113 may be configured to log information about incoming and outgoing calls, including phone numbers and associated participant identifying data, timestamp information regarding start and stop times. In some example's VOIP system 113 supports voice messaging that enables incoming messages to be recorded. In some examples, VOIP system 113 may enable incoming and outgoing calls to be recorded.

In example embodiments, enterprise network 110 includes a CRM agent 119 that provides the enterprise network 110 with an interface to CRM system 200.

In example embodiments, enterprise network 110 also includes a CRM support agent 114 that provides the enterprise network 110 with an interface to CRM support system 120. In example embodiments, CRM support agent 114 includes a connector 116 that functions as an interface module between components of the enterprise network 110 and the CRM support system 120. For example, connector 116 is configured to interact with systems within the enterprise network 110 (such as mail server 112, VOIP system 113 and user equipment (UE) devices 104) to extract information about activities (such as communication activities and other enterprise-account interaction activities) and provide that information to CRM support system 120.

As will be described in greater detail below, in example embodiments, the CRM support agent 114 has access to (or includes selected functionality of) a multi-threading recommendation module 118 that is configured to compute a recommendation to improve the multi-threaded sales approach of a sales opportunity.

In example embodiments, enterprise network 110 supports a plurality of UE devices 104. Each enterprise user 182 is associated with one or more respective UE devices 104. In example embodiments, a UE device 104 may be a smartphone, computer tablet, laptop computer, desktop personal computer, wearable electronic device or other communication enabled computer device. In example embodiments, UE devices 104 are configured with a personal information manager (PIM) module 106. Among other things, the PIM module 106 includes an email client, as well as one or more other functions such as calendaring, task managing, contact managing, note-taking, journal logging, and web browsing functions. The PIM module 106 will typically store associated PIM data that includes, among other things, user calendar data, user address book data, user email data and user messaging data. Examples of PIM modules 106 include modules that support basic communications and scheduling services that the user of a UE device 104 is registered with, such as Google Gmail™, Microsoft Outlook Exchange Web Service, and/or Lotus Domino. In example embodiments, some or all of the PIM data associated with a user 182 may be stored locally on the UE device 104 associated with the user, and in some examples, all or parts of the PIM data may be stored at a remote server hosted by or for enterprise network 110 that is accessible through a communication network to the UE device 104. In various embodiments, some or all of the PIM data for users 182 that is stored at UE devices 104 or other remote server is accessible to CRM support agent 114. In some examples, one or more connectors 116 are associated with CRM support agent 114 to enable the CRM support agent 114 to periodically retrieve the PIM data of registered users 182.

In example embodiments, UE devices 104 each include a CRM support client 108 that is configured to interface with the connector 116 of CRM support agent 114 to support the systems and methods described herein, including the exchange of PIM data described above. In example embodiments, a user 182 may have multiple associated UE devices 104 across which PIM data is synchronized. In some examples, a UE device 104 associated with a user could be a virtual device (e.g., a user virtual desktop) that is hosted by a server within enterprise network 110 and accessed by a remote access device (e.g., a thin client device).

CRM System 200

In example embodiments, CRM system 200 may be implemented using a known CRM solution such as, but not limited to, Salesforce.com™, Microsoft Dynamics™, InterAction™ or Maximizer™, and includes a CRM database 170 that includes customer data (e.g., CRM data) for accounts 190 that are tracked by enterprise 180. The CRM data that is stored in a CRM database 170 for an account 190 may for example include: (I) general account data, (II) opportunity data about specific opportunities that the enterprise has undertaken in the past, is currently undertaking, or is proposing to undertake in the future with accounts 190, and (III) individual contact data that includes contact information for individual contacts who are members of the accounts 190.

CRM Support System 120

In example embodiments, CRM support system 120 is configured to provide enhanced CRM information and functionality that supplements CRM System 200. CRM support system 120 includes a relationship database 122 for storing relationship data generated in respect of the accounts 190 of interest to enterprise 180. In example embodiments, similar to CRM database 170, relationship database 122 may store, in respect of each account 190 (e.g., each customer or client of enterprise 180), relationship data objects 124 that include: (I) account data 126 that provide general information about the account 190, (II) opportunity data 128 about specific opportunities that the enterprise has undertaken in the past, is currently undertaking, or is proposing to undertake in the future with the account 190, (III) individual contact data 130 that includes contact information for individual contacts 192 (e.g., employees) who are associated with the account 190, (IV) user data 132, that includes information about enterprise users 182 who are involved in the relationship with an account 190, (V) user-contact relationship strength data 134, and (VI) activity data 136 that includes information about activities between enterprise 180 and account 190. The data in relationship database 122 may include some or all of the information stored at CRM database 170, as well as supplemental information.

In example embodiments, the CRM Support System 120 interfaces with connector 116 of CRM support agent 114 and other possible data sources to collect and update of data stored in relationship database 122. In some examples, the CRM support system 120 is configured to periodically refresh (e.g., for example on a timed cycle such as once every 24 hours) the content of data objects 124 such that the data maintained in relationship database 122 always includes current or near-current information. The CRM support system 120 may periodically refresh the information stored in relationship database 122 based on information from a plurality of sources. For example, CRM support system 120 may obtain data from the CRM database 170 of CRM system 200, from sources within enterprise network 110, and from other data sources that are available through communication network 150.

Account data 126: In example embodiments, the basic data included in account data 126 stored at relationship database 122 may include, for each account 190, some or all of the fields listed in the following Table 1, among other things:

TABLE 1
Account Data Fields:

| Field | Field Description |
|---|---|
| Enterprise ID | Unique identifier assigned to |
| | Enterprise 180 |
| Account ID | Unique identifier assigned to |
| | Account 190 |
| Account Industry Code | Code that identifies primary industry |
| | type of customer organization (e.g., |
| | Standard Industrial Classification |
| | (SIC) Code and/or North American |
| | Industry Classification System |
| | (NAICS) Codes) |
| Number of Employees | Number of Employees of Account |
| | Organization |
| Account Size Score | Score assigned based on size of |
| | account organization (e.g., |
| | organization size of 1500+ |
| | employees = 10 points; 1000 to |
| | 1500 = 9 points; 750-1000 = 8 |
| | points, etc.) |
| Account Annual Revenue | Annual Revenue of account |
| | organization for one or more |
| | previous years |
| Owner User ID | User ID of enterprise user 182 who |
| | owns the account (e.g., user 182 |
| | who has primary responsibility for |
| | enterprise-account relationship) |
| Name | Name of Account (e.g., company or |
| | organization name) |
| Top User-Account Relationship | The enterprise user 182 that has the |
| | strongest relationship with the |
| | account 190 |
| Account Status Indicator | Indicates Current Status of Accounts |
| | being targeterd (e.g., Current Active |
| | Account with Open Opportunity; |
| | Current Active Account with no Open |
| | Opportunity; Active account, |
| | Exploratory Relationship; Inactive |
| | Account; Inactive Account, prospecting) |

The fields “Account Active Indicator” can be used for an indicator that indicates if an account is currently active or is not currently active (e.g., inactive). In some embodiments, an active account is an account 190 that the enterprise 180 currently has an open opportunity with, or is a current customer or client, or has been a customer or client within a predefined prior time duration (e.g., within last year). In some examples, inactive accounts can be classified as historic accounts or prospective accounts. Inactive historic accounts may for example be previously active accounts that have been dormant (e.g., no open opportunities and currently not a current customer or client) for greater than a predefined prior time duration (e.g., more than one year). Inactive prospective accounts may for example be potential accounts that were never active but that are of interest to enterprise 180, for example organizations in an industry of interest to the enterprise 180, but whom the enterprise has not yet started prospecting.

Opportunity data 128: In example embodiments, the basic data included in opportunity data 128 stored at relationship database 122 may include, for each opportunity with each account 190, opportunity records that include some or all of the fields listed in the following Table:

TABLE 2
Opportunity Data Fields:

| Field | Field Description |
|---|---|
| Opportunity ID | Unique identifier assigned to |
| | Opportunity |
| Account ID | Account ID of the account that is the |
| | target of the opportunity |
| Created Date | Date opportunity registered with |
| | CRM support system |
| Closed Indicator | Indicates if opportunity is closed |
| Closed Date | Date Opportunity was closed |
| Stage Data | Indicates current stage of open |
| | opportunity, and when prior stages |
| | were completed (e.g., (i) find leads |
| | (prospecting), (ii) connect, (iii) |
| | qualify leads, (iv) present, (v) |
| | overcome objections and (vi) close.) |
| Milestone Data | Indicates milestones that have been |
| | achieved and when they were |
| | achieved (e.g.: Present Stage |
| | Milestones: (1) Detailed Demo; (2) |
| | Buy-in from Lead Contact; (3) |
| | Timeline Confirmed) |
| Multi-thread Score Data | Indicates current Multi-thread score, |
| | and Multi-thread scores at times |
| | when stages and milestones |
| | completed. Multi-thread score is |
| | indicative of a perceived suitability |
| | of combined members of the |
| | Account Teams and Enterprise |
| | Teams that are participating in the |
| | opportunity. |
| Won Indicator | Indicates opportunity closed |
| | successfully (e.g., with a sale) |
| Opportunity Size Score | Score that represents a size or |
| | dollar value of the opportunity |
| Projected Budget | Indicates projected budget of |
| | Account for opportunity |
| Product/Service ID | ID(s) of products or services that |
| | opportunity relates to |
| Product/Service Units | Projected number of units of product |
| | or service that opportunity will |
| | require |
| Main Contact ID | Contact ID of lead contact for |
| | opportunity with the account |
| Main User ID | Contact ID of lead user for |
| | opportunity |
| Account Team (Purchasing Team) | Contact IDs of all contacts |
| | participating in the opportunity. (can |
| | include timestamp information |
| | indicating team entry/exit) |
| Enterprise Team (Selling Team) | Contact IDs of all enterprise users |
| | participating in the opportunity. (can |
| | include timestamp information |
| | indicating team entry/exit) |
| Last Activity Date | Date of most recent activity |
| | recorded in respect of opportunity |
| Event ID | ID of marketing event that resulted |
| | in Opportunity (if known) |
| Opportunity Pattern Data | One or more tensors of opportunity |
| | attributes (e.g., static opportunity |
| | feature vector Fs, described below) |

Opportunity data may be updated over time as the opportunity 194 progresses, with updates being timestamped. Initial information about an opportunity 194 may be initially provided by an authorized user 182 at the time that an opportunity 194 is opened. In some examples, an opportunity is opened (e.g., assigned an opportunity ID and tracked in CRM system and/or CRM support system 120 as a discrete opportunity) once a lead is qualified in respect of a sales matter. In other examples, the timing for opening an opportunity can be based on other predefined criteria.

Contact data 130: In example embodiments, the basic data included in contact data 130 stored at relationship database 122 may include, for each contact 192 at account 190, contact records that include some or all of the fields listed in the following Table 3, among other things:

TABLE 3
Contact Data Fields:

| Field | Field Description |
|---|---|
| Contact ID | Unique contact identifier |
| Active/Inactive Indicator | Indicates if contact is active or |
| | inactive |
| Date Created | Date contact added |
| Account ID | Account ID of the account the |
| | contact is associated with (referred |
| | to as “contact's account”) |
| Department | Name of contact's department in |
| | contact's account |
| Department ID | Numerical value that maps to |
| | Department (based on pre-defined |
| | mapping rules) |
| Account Industry Code | Industry Code for contact's account |
| Position/Title | The position/title of the contact in |
| | contact's organization |
| Title Score | Hierarchal Score assigned to Contact |
| | based on contact's position at |
| | contact's organization (e.g., may be |
| | defined by a look up table that maps |
| | position titles to scores: president = |
| | 20 points, CEO = 20 points, VP = 18 |
| | points, senior manager = 14 points; |
| | partner = 16 points, etc.) |
| Contact-Enterprise Relationship | Score That Indicates Perceived |
| Score | Value of the Relationship with the |
| | Contact |
| First Name | Contact's First Name |
| Last Name | Contact's Last Name |
| Full Name | Contact's Full Name |
| Primary Email | Contact's Primary Email |
| Primary Phone | Contact's Primary Phone |
| Preferred Marketing Event | Preferred Event Type for Contact |
| Contact Origination Type | Type and ID of activity or event that |
| | caused contact to be added as an |
| | Active Contact (e.g., email |
| | communication activity, meeting |
| | communication activity, new outlook |
| | or other personal information |
| | management system contact |
| | addition) |
| Image | One or more images obtained from |
| | on-line sources (e.g., Linked-In ™ |
| | profile picture) |
| Opportunity ID(s) | ID's of opportunities that the contact |
| | is associated with |

As noted above, contacts can be indicated as active or inactive. In example embodiments, an active contact can be a contact that has been a party to an activity (as tracked in activity data 136 below) within a predefined prior time period (e.g., last 18 months) and/or meets other pre-defined criteria including for example criteria as set by privacy and solicitation legislation or regulations. Inactive contacts are contacts that are not currently active and may in some examples be classified in one or more categories such as inactive historic contacts (e.g., contacts that were previously active contacts), and inactive prospective contacts (e.g., contacts working in industries that are of interest to the enterprise or with active accounts, but who are not historic contacts).

User data 132: In example embodiments, the basic data included in user data 132 stored at relationship database 122 may include, for each user 182 that has a relationship with a contact 192 at the account 190, user records that include some or all of the fields listed in the following Table 4, among other things:

TABLE 4
User Data Fields:

| Field | Field Description |
|---|---|
| User ID | Unique user identifier |
| Account ID | Account ID of the subject account |
| Department | Name of user's department in the |
| | enterprise organization |
| Title | Title/position of user within |
| | enterprise organization |
| User-Account Relationship Score (*) | Score That Indicates Perceived |
| | Value of User's Relationship With |
| | Account |
| Opportunity ID (*) | Opportunity ID for opportunity for |
| | which user is member of the |
| | enterprise team (e.g., selling team) |

(*) indicates fields that can be repeated for multiple accounts/opportunities

User-Contact Relationship data 134: In example embodiments, the basic data included in user-contact relationship data 134 stored at relationship database 122 includes information for each known user-contact relationship that exists between a user 182 within enterprise 180 and a contact 192 within an account 190. User-contact relationship records included in user-contact relationship data 134 may, for example, include some or all of the fields listed in the following Table 5, among other things:

TABLE 5
User-Contact Relationship Data Fields:

| Field | Field Description |
|---|---|
| User ID | Unique user identifier |
| Contact ID | Contact Unique Identifier |
| Account ID | Contact's Account |
| Start Date | Date when relationship between |
| | user and contact started |
| Relationship Origination Indicator | Activity ID and/or event ID of the |
| | activity/event that first triggered |
| | Contact/user relationship |
| Active Indicator | Indicates if relationship is currently |
| | active |
| User-Contact Relationship Score | Score that indicates perceived |
| | strength of User-Contact |
| | Relationship Strength |
| Last Activity Date | Date of last recorded activity |
| | including user and contact |

Activity data 136: In example embodiments, the activity data 136 stored at relationship database 122 may include data for activities related to the entity-account relationship. Activities may for example include communication activities and documentation activities among other things. Activity data 136 may include respective activity records 138 for each logged activity. Table 6 below provides a generic example of fields that may be included in an activity record 138, depending on the type of activity and availability of information:

TABLE 6
Activity Data Fields:

| Field | Field Description |
|---|---|
| Activity ID | Unique identifier assigned to activity |
| Account ID* | Identity of Account whose contacts |
| | participated in the activity |
| Opportunity ID* | Identity of the opportunity(ies) that |
| | activity related to |
| Organizer ID | User ID of enterprise user that |
| | organized activity (e.g., email sender of |
| | meeting organizer) |
| Activity Type Indicator | Value that identifies the type of |
| | enterprise-account interaction |
| | activity (e.g., (i) communication |
| | activity: incoming email, outgoing |
| | email, incoming meeting |
| | request/calendar invite, outgoing |
| | meeting request/calendar invite, |
| | incoming phone call, received |
| | voicemail message, outgoing phone |
| | call, in-person meeting, outgoing |
| | voicemail message, virtual meeting, |
| | combination of in-person and virtual |
| | meeting (ii) documentation activity: |
| | proposal submitted, draft statement |
| | of work (SOW) submitted; final |
| | SOW submitted; contract submitted |
| | for review). |
| Document ID | ID of document template (can be |
| | used to identify content of standard |
| | form email in the form of a |
| | communication action, or to identify |
| | document template in case of |
| | documentation activity) |
| Start Time | Date and time stamp indicating start |
| | of activity |
| Activity Duration | Duration of activity (e.g., length of |
| and/or End Time | meeting or phone call), or data and |
| | time stamp indicating end of activity |
| NLP Data | Word/Phrase/topical data extracted |
| | from text of written or transcribed |
| | verbal communication activities |
| Sentiment Indicator | Indicator provided manually or by |
| | NLP algorithm as to sentiment of |
| | activity (e.g.: negative to positive |
| | sentiment on scale of 1 to 5, in |
| | example embodiments, may be |
| | determined at CRM support agent |
| | 114 and sent by connector 116 to |
| | data tracking module 122) |
| Content Count* | Counts number of occurrences of |
| | predefined words in communication |
| | activity (e.g., product name, |
| | competitor product name). (In |
| | example embodiments, may be |
| | determined at CRM support agent |
| | 114 and sent by connector 116 to |
| | data tracking module 122) |
| Participants - Account* | Contact IDs or other available |
| (ID/Title/Department) | identifier and title/department |
| | information for all individuals |
| | involved on account side who where |
| | invited (Can be grouped according |
| | to type of participation per |
| | communication activity, for |
| | example, for an email, the type of |
| | participation can include: (i) sending |
| | party; (ii) participant listed in “TO” |
| | field; (iii) participant listed in “CC” |
| | field. |
| Participants - Enterprise* | User IDs or other available identifier |
| (ID/Title/Department) | and title/department information for |
| | all individuals involved on enterprise |
| | side of activity. (Can be grouped |
| | according to type of participation |
| | per communication activity, for |
| | example, for an email, the type of |
| | participation can include: (i) sending |
| | party; (ii) participant listed in “TO” |
| | field; (iii) participant listed in “CC” |
| | field. |
| Subject | e.g., Information included in email |
| | Subject fields or meeting “Subject” |
| | field by meeting organizer. |
| Location | e.g., Information included in |
| | meeting “Location” field by meeting |
| | organizer |
| Additional Information | Additional descriptive information |
| | about activity (e.g., information |
| | included in the open format field of |
| | a meeting scheduling form) |
| Average Enterprise-Contact | Average Enterprise-Contact |
| Relationship Score | Relationship Score of Account |
| | participants |
| Average Title Scope | Average Title score of Account |
| | participants |

*Indicates fields that will be repeated as required

Data Object Storage and Collection: In example embodiments, the CRM support system 120 includes both current and historic records in data objects 124, enabling changes in data, including data of the type included in the data object fields noted above, to be compared and plotted over time. For example, current and historical time-stamped versions of the records (or selected data fields) included as data objects 124 may be stored at relationship database 122.

The data included in data objects 124 in relationship database 122 may be obtained by CRM support system 120 from different sources using different methods. For example, some information may be collected from enterprise users 182 through data entry provided through user interfaces supported by CRM support agent 114. Some information may be gathered from third party data providers (e.g., contact information and account information pertaining to inactive prospective accounts and contacts, and supplementary information regarding contacts 192 and accounts 190). Some information may be gathered directly or indirectly (for example via CRM agent 119) from CRM system 200. Some information may be gathered through automated monitoring of enterprise network 110 activities and events, including activities at mail server 112 and UE device PIM 106 activities such as email activities, calendar activities and contact management activities. CRM support system 120 may be configured to perform periodic email, calendar and contact synchs with CRM support agent 114 for updates.

By way of example, in the case of activity data 136, in example embodiments, CRM support agent 114 is configured to automatically collect information about communication activities between users 182 associated with the enterprise 180 and external contacts 192 associated with an account 190. These communication activities may for example be electronic communications such as email, meetings that are tracked in calendar systems and/or scheduled through email communications, and telephone calls that occur through a VOIP system that enables call logging. Each of these interactions have associated electronic data that includes a contact identifier (e.g., email address or phone number for contact 192), time stamp information for the interaction, and a user identifier (e.g., data that identifies the user(s) 182 of the enterprise 180 and account contacts 192 that were involved in the communication activity).

In example embodiments, CRM support agent 114 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, CRM support agent 114 may collect information from an enterprise mail server 112 and VOIP system located within enterprise network 110 and/or from PIM modules 106 associated with UE devices 104, via the connector 116.

In some examples, connector 116 may collect information from the mail server 112. For example, in some embodiments connector 116 is configured to intermittently run a batch process to retrieve email messages from the mail server 112 so that communication activity data can be derived from the email messages and provided through communication network 150 to the relationship database 122. In some examples, the connector 116 is configured to extract selected information from email messages as contact interaction data and other metadata. For each email message, the extracted information may for example include any external email address included in the sender, recipient and carbon copy (CC) and blind carbon copy (BCC) recipient email address fields, along with a send or receive timestamp applied to the email message by the mail server 112. In example embodiments, the extracted information can also include information that identifies any enterprise users 182 that are participating in the email as sender or recipient or CC recipient. In example embodiments, the extracted information can also include information that identifies any account members 192 that are participating in the email as sender or recipient or CC recipient.

In example embodiments, meeting requests and invites will be included among the email messages that are processed by mail server 112, and connector 116 is configured to include email addresses in the meeting invitee list and organizer fields in the contact interaction data extracted from the emailed meeting invite. In some examples, connector 116 may also be configured to interface with CRM support clients 108 to receive data from the PIM modules 106 of UE devices 104 associated with the enterprise network 110. In some examples where enterprise network 110 supports phone call logging, for example in Voice-Over-Internet-Protocol (VOIP) implementations supported by a VOIP system, connector 116 may be further configured to interact with a VOIP server to collect information such as metadata about external phone numbers used for outgoing and internal calls, and timestamp information, for inclusion in communication activity data.

In at least some examples, in addition to collecting metadata (e.g., information about participants, time stamps, etc.) about communication activities, CRM support system may also collect substantive information. In some examples, that information could be the actual text of information that is include in electronic communications such as emails, text messages, calendar invites. In some examples, a speech to text conversion engine may be used to transcribe audio data from communication events such as phone calls, video conferences and voice mail messages that occur through enterprise network 110, and that text could be stored as part of the activity data.

In some examples, text from electronic messages or text obtained from verbal communication transcriptions may be analyzed and abstracted using an natural language processing (NLP) module that has been trained or otherwise configured to generate vector embeddings that indicate content of interest (including for example, embeddings that represent one or more of word level content, phrase level content, word grouping topical content and/or a sentiment). In some examples, such NLP embedding may be performed at the enterprise network 110. For example, connector 116 may include an NLP module 117 that is configured to generate embeddings in respect of electronic and audio communications activities and provide that information to CRM support system 120. Among other things, NLP module 117 can perform filtering, text classification and sentiment analysis functions that can enable the substantive content of communications activities to be represented as numeric tensors that can be processed using automated solutions.

In example embodiments, CRM support system 120 is configured to run an update process periodically (e.g., every 24 hours) to update data objects 124.

Relationship Scoring

It will be noted that a number of the data objects 124 include relationship scoring information that assign values to relationships based on metrics described in greater detail below. For example, relationship scores can include: account data 126 includes a “Top User-Account Relationship” that identifies the enterprise user 182 that has a highest overall relationship score with the subject account 190; contact data 130 includes a “Contact-Enterprise Relationship Score” that that indicates a perceived value of the relationship of enterprise 180 with the subject contact 192; user data 132 includes a “User-Account Relationship Score” that indicates perceived value of user's relationship with contact; and user-contact relationship data includes a “User-Contact Relationship Score” that indicates perceived strength of the user-contact relationship.

According to example embodiments, the CRM support system 120 includes a scoring module 123 that is configured with a set of relationship score prediction models 123A for computing each of the respective relationship scores when updating the data objects 124. In at least some examples, these scores are calculated by scoring module 123 based on communication activities between enterprise users 182 and account contacts 192, such as the communications activities that are tracked as part of activity data 136. By way of example, the user-contact relationship score for an enterprise user 182-account contact 192 could be based on a communication score that is based on features such as, among other things: activity type (e.g., incoming email, outgoing email, incoming meeting request/calendar invite, outgoing meeting request/calendar invite, incoming phone call, outgoing phone call, in-person meeting, on-line meeting, video conference); frequency (e.g., number of communication activities with a defined time period); recentness of communication activities; and length of communication activity, among other things.

By way of illustrative non-limiting example, a contact-user communication score based on frequency of communication, recentness of communication, and type of communication could be determined based on a pre-defined model or algorithm such as follows:

Raw communication score=(total number incoming emails in last week from contact listing user as direct recipient)*(W1)+(total number outgoing emails in last week from user listing contact as direct recipient)*(W2)+(total number incoming emails in last week from contact listing user as CC recipient)*(W3)+(total number outgoing emails in last week from user listing contact as CC recipient)*(W4)+(total number of phone calls, in-person meetings, and virtual meetings involving both user and contact in last week)*(W5)+(total number incoming emails in last month from contact listing user as direct recipient)*(W6)+(total number outgoing emails in last month from user listing contact as direct recipient)*(W7)+(total number incoming emails in last month from contact listing user as CC recipient)*(W8)+(total number outgoing emails in last month from user listing contact as CC recipient)*(W9)+(total number of phone calls, in-person meetings, and virtual meetings involving both user and contact in last month)*(W10)+(total number incoming emails in last 6 months from contact listing user as direct recipient)*(W11)+(total number outgoing emails in last six months from user listing contact as direct recipient)*(W12)+(total number incoming emails in last 6 months from contact listing user as CC recipient)*(W13)+(total number outgoing emails in last six months from user listing contact as CC recipient)*(W14)+(total number of phone calls, in-person meetings, and virtual meetings involving both user and contact in last week)*(W15)+(total number of all communications activities involving both user and contact over lifetime of user-contact relationship)*(W16)

Where: W1 to W16 are predetermined weights. (e.g., W1=W2=7; W3=W4=3; W5=8; W6=W7=5; W8=W9=2; W10=6; W11=W12=3; W13=W14=1; W15=4; W16=1).

It will be noted that the above example of the Raw Communication Score enables different types of communication activities to be weighted differently, more recent communication activities to be rated differently than older communications activities, and different types of participation (e.g., sending party, direct “TO” field recipient, or “CC” field recipient in the case of email) to be weighed differently. In some examples, weighting could also be applied based on the number of participants in each communication activity. This enables these factors to be given different levels of importance when determining relationship strength.

The particular equation shown above is illustrative and can be varied in different examples. In some applications, some of the communication activities noted above may be omitted or combined, among other possibilities.

In some examples, the weights may be manually set, and in some examples, the weights may be learned using a linear regression machine learning based model. In example embodiments, the communication score may be determined using a learned model that has been learned using machine learning techniques based on historic communication and relationship data.

In example embodiments the raw communication score may be normalized to a communication score based on comparison with historical data and/or data for other user-contact relationships or other scaling methodology to a range (for example 0 to 1). In some examples, the normalization may be based on data limited to the enterprise. In some examples, the normalization may be based on data from an industry. In some examples, normalization may be related to a specific account. In some examples, a communication momentum value may be based on trends over time in the metrics represented in the raw score calculation noted above.

In some examples a User-Contact Relationship Score could be a composite of the contacts title score and a communication score based on the above attributes (e.g., contact title score*communication score). In some examples the User-Contact Relationship Score may be decided based only on the communication score. In some example embodiments, User-Contact Relationship Score could be represented as a discrete ranking within a relative scale such as “3=high”, “2=medium”, “1=low”.

In some examples, “Contact-Enterprise Relationship Score” could be based on a combination (e.g., sum or product) of all of the individual User-Contact Relationship Scores that a contact 192 has with users 182 of enterprise 180. In some examples, a “User-Account Relationship Score” could be based on a combination (e.g., sum or product) of all of the individual User-Contact Relationship Scores that a user 182 has with account contacts 192. In some examples, the “Contact-Enterprise Relationship Score” could be based on a combination of all the individual User-Contact Relationship Scores across all user-contact relationships between an enterprise 180 and an account 190.

Further examples of relationship scoring techniques that can be applied are described in U.S. Pat. No. 9,633,057, issued Apr. 25, 2017, the content of which is incorporated herein by reference.

In some example embodiments, current relationship scores are included in the data objects. In some example, historic communication and relationship scores may also be stored that relate to key events, for example when stages in a sales cycle for an opportunity are completed or when defined milestones are achieved in respect of an opportunity. In some examples, a plurality of milestones could be associated with each stage of an opportunity. For example the “Present” stage could include the milestone activities: (1) Detailed Demo; (2) Buy-in from Lead Contact; (3) Timeline Confirmed. Although scoring module 123 is shown as part of CRM support system 120, some or all of the functionality of scoring module 123 can hosted at other locations in the environment of FIG. 1, including for example at CRM support agent 114 or CRM system 200, or elsewhere.

Multi-Thread Scores

As noted above, the opportunity data 128 for opportunities 194 can include multi-thread score data. In this regard, in example embodiments, the scoring module 123 can also include a multi-thread model 123B that is configured to calculate multi-thread scores in respect of opportunities 194. In example embodiments, the multi-thread score is numeric value that scores the collective group of account contacts 192 and enterprise users 182 that are associated with an opportunity 194(j) (hereinafter the “opportunity team”). The multi-thread score may for example be calculated using predetermined model 123B (which may include a rules-based model, a machine learning based model, or combinations thereof) to enable a comparative analysis of the opportunity team at different times of an opportunity and between different opportunities 194. In some examples, the multi-thread score may be based on a combination of at least two of: the number of contacts 192 and users 182 associated with an opportunity; the titles of such contacts 192 and users 182; the departments of such contacts 192 and users 182; and one or more of the relationship scores relating to such contacts 192 and users 182. The model may be configured to give a higher score for title and departmental diversity within the opportunity team.

In a non-limiting example embodiment, multi-thread model 123B may apply a model that includes the following function to calculate a base multi-thread score:

BASE MT Score=(SUM of Contact-Enterprise Relationship Scores for all contacts that are members of the Account Team)*(Wt1) PLUS (SUM of Contact-Enterprise Relationship Scores for all contacts that are members of the Enterprise Team)*(Wt2).

In some examples, the BASE MT Score may then be adjusted to account for title and departmental diversity as follows:

ADJUSTED MT Score=BASE MT Score*(Wt3)+(number of different account-side departments included in opportunity)*(Wt4)+(number of different title scores included within each account-side department included in opportunity)*(Wt5)+(number of different enterprise-side departments included in opportunity team)*(Wt6)+(number of different title scores included within each enterprise-side department included in opportunity)*(Wt7)

Where: Wt1 to Wt7 are predetermined weights that have either been manually set or have been learned using machine learning techniques.

It will be noted that weighting for the type of participation (e.g., sending party, listed in “TO” field, listed in “CC” field in the case of email) of users and contacts is embedded in the Raw Communication Score used as the basis for relationship scoring, and thus is among the factors accounted for in the BASE and ADJUSTED MT Scores. However, in some examples, further factors can be included into the equation for the ADJUSTED MT Scores to allow additional weight based tuning of the scores to account for the different types of participation by Account and Enterprise team members.

In some examples, the BASE MT Score may be calculated based on a sum of all the user-contact relationship scores for user-contact pairs in the opportunity team, rather than or in addition to overall user-account and contact-enterprise relationship scores.

In example embodiments, Multi-thread Score Data for each opportunity can include a set of scores that includes current BASE and ADJUSTED MT Scores, as well as historic BASE and ADJUSTED MT Scores that have been calculated at the completion of stages and milestones of the opportunity.

Pattern Generation

In example embodiments, a computer implemented pattern generation (PG) module 121 is provided that is configured to perform a number of functions and processes in respect of the basic data collected and stored in the relationship database 122 to extract further analytical information about accounts 190, opportunities 194, contacts 192 and users 180. In FIG. 1, pattern generation module 121 is integrated into CRM support system 120 enterprise-side CRM support agent 114. However, in some examples, some or all of the functionality of pattern generation module 121 could be hosted at enterprise-side CRM support agent 114 or elsewhere in the computing environment.

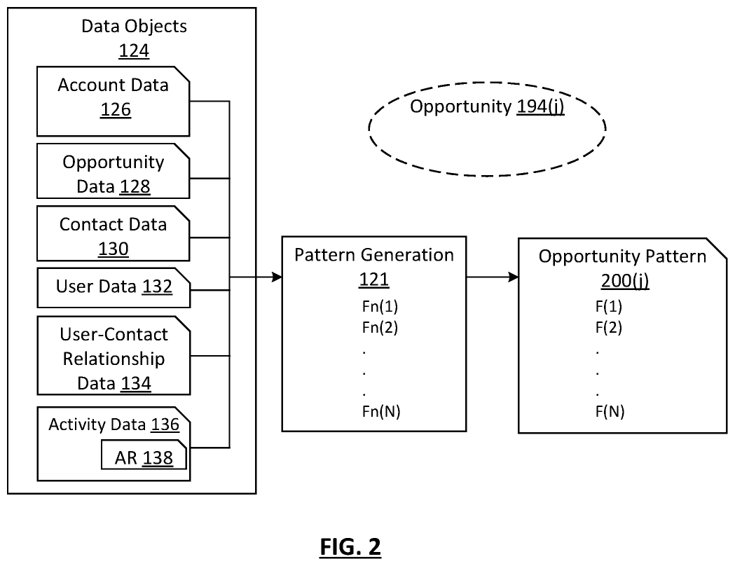

Referring to FIG. 2, in an example embodiment, pattern generation module 121 is configured to generate a respective opportunity pattern 200(j) for a specific opportunity 194(j) based on the basic data included in data objects 124. In example embodiments, an opportunity pattern 200(j) is defined by a set of pattern features F(1) to F(N) that quantitatively represent a specific opportunity 194(j) (e.g., N equals the number of pattern features that define an opportunity pattern 200(j), opportunity pattern 200(j)=(F(1), . . . , F(N)). In example embodiments, some of the pattern features F(1) to F(N) may be single value scalers, and some of the pattern features F(1) to F(N) may be multi-dimensional tensors. A tensor is an ordered set or array of numbers, typically with significance attached to the order in which the numerical values appear in the tensor, as well as the numerical values themselves. Each pattern feature F(1) to F(N) is a different type of feature that numerically represents a unique property or set of properties of the opportunity 194(j).

In example embodiments, the pattern generation module 121 is preconfigured with a set of respective functions fn(1) to fn(N) for generating the respective pattern features F(1) to F(N). Each function fn(i) (where fn(i) represents a generic function, 1≤i≤N) is configured to map a defined set of variables extracted from the data objects 101 to a respective pattern feature F(i). In example embodiments, the functions fn(1) to fn(N) and their respective sets of input variable types and output feature types are predetermined based on analysis of data objects 124 pertaining to several historical opportunities. In some examples, such analysis includes statistical analysis methods, such as, for example, principal component analysis, performed based on historic opportunity data using iterative simulation, modeling and analysis techniques. In some examples, the set of functions fn(1) to fn(N) may include deterministic functions that combine variables according to predetermined rules, machine learning based functions that have been trained to implement a non-linear prediction model, or a combinations of both. In the case of a pattern feature F that is single value scaler, the respective function fn may be configured to apply respective predetermined weight values to input variables, and then use a mathematical operator to combine the resulting weighted variable values. For example, the weighted variable values could be summed together, with the respective weight values each representing a relative contribution of the respective input variables as determined through statistical analysis methods such as principal component analysis.

In some example embodiments, pattern generation module 121 may be configured to apply the same set of functions fn(1) to fn(N) in respect of all opportunities 194 for all types of accounts industry types and sizes for all enterprises. However, pattern generation module 121 may be configured to apply tailored sets of functions to different specific opportunity scenarios. In at least some examples, a generic set of functions may be applied until a threshold amount of data exists for closed opportunities to permit a more specific set of functions to be configured and applied. By way of example, once a particular enterprise 180 has completed a sufficient number of opportunities, it may be possible to develop a set of functions fn(1) to fn(N) that are based primarily on analysis of the historical data for that particular enterprise 180. In a further example, for an enterprise without a large enough set of historical data, a function set designed for a specific industry based on analysis of anonymized historical information for that specific industry (e.g., accounting firms) could be used.

In example embodiments, one of the functions fn(.) that is implemented by a predefined model is configured to generate, for each opportunity 194, a multi-dimensional static opportunity feature vector Fs that includes an ordered set of values that represent respective attributes static attributes of the subject opportunity 194. Static attributes can refer to attributes of an opportunity that are generally not expected to change over the duration of the opportunity, particularly after a lead has been qualified. For example, the static attributes can include one or more of the following: enterprise ID, account ID, industry code, account size score, account annual revenue, opportunity type, deal quantity, deal size score, product/service ID, Product/Service Units and/or geographic indicator. In at least some examples, the static opportunity feature vector Fs determined in respect of a subject opportunity is determined once the lead for an opportunity is qualified and is stored as part of the opportunity record for that opportunity. Among other things, the respective static opportunity feature vectors Fs that are determined in respect of open and historic opportunities can be used to identify and cluster ongoing and historic opportunities for analysis purposes.

Referring to FIG. 3, in example embodiments CRM support system 120 is configured to perform a configuration process during which pattern generation module 121 is used to generate an initial set of opportunity patterns 200 for a pattern database 325 that may be stored in a database such as relationship database 122 (or in a database that stored at enterprise network 110 or elsewhere). As indicated in block 302, the process begins with selection of a closed opportunity 194(i) from the opportunities identified in the opportunity data 104 associated with enterprise 180.

As indicated in block 304, a set of functions fn(1) to fn(N) is selected for processing the closed opportunity. As noted above, the set of functions fn(1) to fn(N) may be generic for all opportunities in which case the selection block 304 is not required. However as noted above, in some examples, one or more functions may be customized, in which case the set of functions that is selected may depend on one or more of the following variables that can be associated with a specific opportunity: enterprise ID, account ID, industry code, account size score, account annual revenue, opportunity type, deal quantity, deal size score, and/or geographic indicator, among other things.

As indicated in block 306, the data required as input to the set of functions fn(1) to fn(N) is then extracted from the data stored in data objects 101 relating to the selected opportunity. As indicated in block 308, the extracted data is preprocessed as required. This may for example include conventional pre-processing operations such as: inferring missing data, removing or otherwise dealing with outliers, standardizing (e.g., scaling) and normalizing data, and aggregating data over a time period, converting qualitative or categorical variables to quantitative numerical values, among other things.

The set of functions fn(1) to fn(N) are applied to the pre-processed input data to generate respective opportunity features F(1) to F(N), as indicated in block 310.

The resulting set of opportunity features F(1) to F(N) (which may include multi-dimensional static opportunity feature vector Fs) collectively provide an opportunity pattern 200(j) for closed opportunity 194(j), and is stored in pattern database 325. The opportunity pattern 200(i) is stored with metadata that provides a creation timestamp and identifies the opportunity ID, account ID and enterprise ID associated with the closed opportunity 194(j), as well as a Won Indicator for the closed opportunity 194(j) in the event that the closed opportunity 194(j) had a successful outcome. The opportunity patterns 200 that are tagged with a Won Indicator collectively form a set of “Successful Opportunity Patterns 315”.

During a configuration mode, the operations represented by blocks 302 to 312 of process 300 can be repeated for several closed opportunities 194, resulting in a set of discrete opportunity patterns 200, each of which corresponds to a respective closed opportunity 194, being stored in pattern database 325.

In example embodiments, after an initial configuration to build the initial content for pattern database 325, operations represented by blocks 302 to 312 can be performed in respect of newly closed opportunities as they are closed, such that the pattern database 325 is continuously augmented with new opportunity patterns 200. In some examples, older opportunity patterns 200 that fall outside of an age threshold may occasionally be archived and removed from pattern database 325.

In some examples, as system administrator (for example an operator of CRM support system 120) may periodically reevaluate the opportunity functions fn(1) to fn(N) to determine if any of the functions fn(1) to fn(N) should be updated. In the event that a decision is made to update the opportunity functions fn(1) to fn(N), the configuration process 300 can be rerun on the historic opportunity data included in data objects 101 to develop a new set of opportunity patterns 200 for future use.

Multi-Threading Recommendation

As noted above, a multi-threading recommendation module 118 may be hosted at enterprise network 110 as part of the CRM support agent 114. Multi-threading recommendation module 118 will now be described in the context of example embodiments of computer implemented systems and methods for automatically determining recommendations to improve the multi-threading of a sale opportunity. In example embodiments, multi-thread recommendation module 118 interacts with components of the systems of FIG. 1 to predict a future action for particular active sales opportunity 194(j) to improve multi-threading of the opportunity 194(j). In the illustrated embodiment, the multi-threading module 118 is shown as part of CRM support agent 114. However, some or all of the functionality of the multi-threading module 118 could be performed at one or more of the other components shown in FIG. 1 in alternative embodiments.

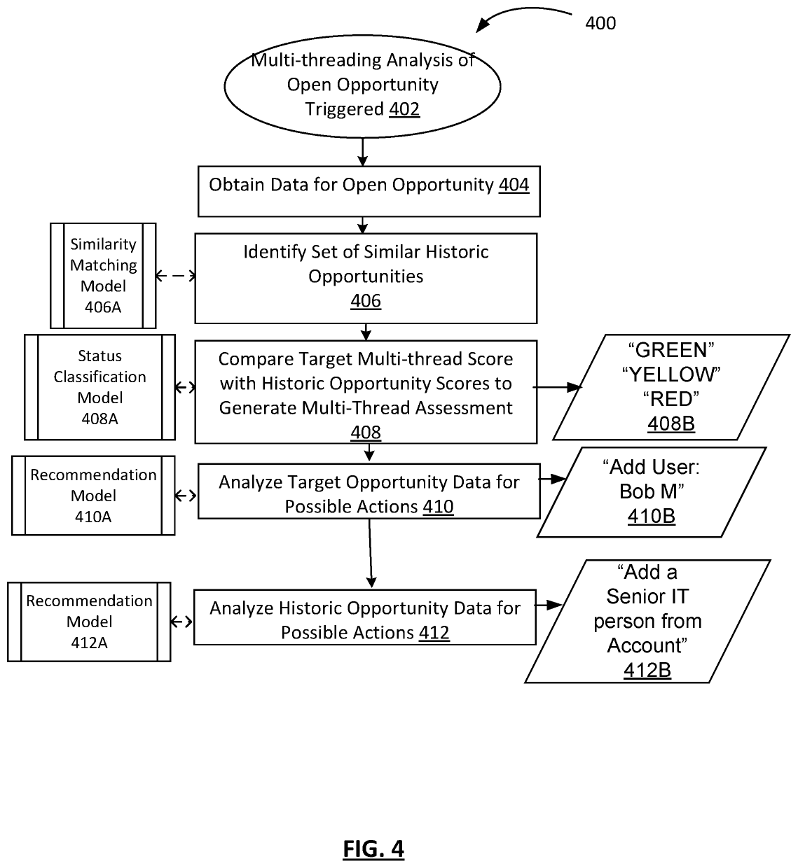

FIG. 4 is a block diagram of a process 400 that can be performed by multi-threading module 118 according to example embodiments. In an example embodiment, the process 400 begins with a defined triggering event 402. In some examples, the triggering event may be caused by manual selection of a particular open opportunity 194(j). For example, the CRM support client 108 on a UE 104 may be configured to present a user interface on a display of the UE 104 that includes information about opportunity 194(j) (e.g., information derived from opportunity data 128 that is retrieved by the CRM support client 108 from CRM support system 120 either through CRM support agent 114 or other interface). The user interface may include a user selectable option to perform a multi-threading analysis of the opportunity 194(j). Upon detecting a user interaction selecting the multi-threading analysis, CRM support client 108 provides a message through enterprise network 110 to multi-threading recommendation module 118 to commence the process 400. In other examples, the triggering event for process 100 could be a batch process triggered in respect of multiple opportunities either as part of a scheduled process or do to an instruction from a system administrator.

As indicated at 404, the multi-threading module 118 will retrieve data for the opportunity 194(j) (referred to hereafter as target opportunity 194(j)) from the relationship database 122. Among other things, the information that is retrieved can include data from opportunity data 120, contact data 130 and user data 132. For example the information retrieved can include some or all of: Account ID, Stage Data, Milestone Data, Multi-thread Score Data (e.g., current Adjusted Multi-thread (MT) Score), Account Team Data (e.g., Contact ID's, departments, title scores); Enterprise Team Data (e.g., User ID's, departments, title scores); and Opportunity Pattern Data (e.g., static opportunity feature vector Fs). It will be noted that the retrieved information includes a number of data items that have been pre-calculated by scoring module 123 and pattern generation module 121. In some alternative examples, the raw data required to calculate one or more of these data items may instead be retrieved and the particular scores and patterns calculated by multi-threading recommendation module as part of the analysis process 400.

As indicated at 406, multi-threading recommendation module 118 is configured to then query relationship database 122 to identify a set of other opportunities 194 that are similar to target opportunity 194(j). In some example embodiments preliminary filtering can be performed to limit the search for similar opportunities to opportunities 194 that the enterprise 180 has successfully completed (e.g., historic opportunities with Won Indicator=“Yes”). The identification of similar opportunities can be based on a comparison of one or more of the opportunity patterns F(1) to F(N) of the target opportunity 194(j) with the group of successfully closed opportunities 194. By way of example, similarity can be based on similarity matching of the static opportunity feature vector Fs for the target opportunity 194(j) with the static opportunity feature vectors Fs for the group of successfully closed opportunities 194.

In some examples, a K-nearest neighbor similarity matching model 406A can be applied to perform similarity matching. For example, the set of similar opportunities can include the K successfully closed opportunities 194 that are closest based on Euclidian distance to the target opportunity 194(j) in the multi-dimensional static opportunity feature space that corresponds to the attributes included static opportunity feature vectors Fs. In some example embodiments K=1, and only one closest neighbor opportunity is selected. In some examples K can be >1 and multiple past opportunities can be included in the set of similar historic opportunities. In example embodiments, K is a hyperparameter that can be user defined.

As noted above, in some examples, static opportunity feature vector Fs includes account ID as one of the feature attributes, and accordingly, the similarity matching will be biased towards opportunities with the same account. In some examples, filtering can be explicitly performed to limit similarity matching to past opportunities with the same account 190. In some examples, the K-nearest neighbor matching can be weighted based on pre-defined weighting of the respective attributes.

As indicated in 408, multi-threading recommendation module 118 is configured to perform a multi-thread assessment of the target opportunity performing a multi-thread score comparison with the similarity matched set of K historic opportunities. In an example embodiment, multi-threading recommendation module 118 applies a predefined status classification model 408A that can be rules-based, machine learning based, or a combination thereof, to perform such assessment. In one example, the current Adjusted Multi-thread Score for target opportunity 194(j) is provided as an input to the model 408A. As noted above, Adjusted Multi-thread Scores are tracked in relationship database 122 for all opportunities and, including at times when stages and milestones are completed. Accordingly, in an example embodiment, multi-threading recommendation module 118 retrieves the respective Adjusted Multi-thread Scores for each of the opportunities included in the matched set of K historic opportunities that corresponds to the same stage and/or milestone level achievement level of the target opportunity 194(j). For example, if the Stage Data and Milestone Data for the target opportunity 194(j) indicates that the target opportunity 194(j) is currently in the “present” stage with only the “detailed demo” milestone completed, then the multi-threading recommendation module 118 will retrieve the respective Adjusted Multi-thread Scores for the set of K historic opportunities that corresponds to that same stage and/or milestone level.

The Adjusted Multi-thread Score for the target opportunity 124(j) can then be compared with the Adjusted Multi-thread Scores for the matched set of K historic opportunities using the status classification model 408A to assess and classify the target opportunity 124(j). For example, a rules-based comparison model may determine the average of the Adjusted Multi-thread Scores for the matched set of K historic opportunities, and then classify the target opportunity 124(j) based on how much its Adjusted Multi-thread Score varies from that of the average. For example, if the target opportunity Adjusted Multi-thread Score falls within a first defined range of the average historic Adjusted Multi-thread Score, then the target opportunity 124(j) can be assigned a “Green” assessment classification, indicating that the multi-threading status for the target opportunity 124(j) is going well or as expected compared to past successful opportunities. If the target opportunity Adjusted Multi-thread Score falls within a second first defined range (outside of the first defined range) of the average historic Adjusted Multi-thread Score, then the target opportunity 124(j) can be assigned a “Yellow” assessment classification, indicating that the multi-threading status of the target opportunity 124(j) is drifting into cautionary status compared to past successful opportunities. If the target opportunity Adjusted Multi-thread Score falls within a third defined range (outside of the first and second defined ranges) of the average historic Adjusted Multi-thread Score, then the target opportunity 124(j) can be assigned a “Red” assessment classification, indicating that the multi-threading status of the target opportunity 124(j) outside of expected norms compared to past successful opportunities.

In example embodiments, the multi-thread assessment classification 408B (e.g., “Green”; “Yellow” or “Red”) for target opportunity 124(j) can be communicated to a UE 104 for output to a user 182 through a user interface generated by CRM support client 108.

In some examples, for example in the case when a “Yellow” or “Red” multi-thread assessment has been generated, multi-threading, recommendation module 118 may perform further analysis operations to identify a recommended multi-threading action for improving the target opportunity Multi-thread Score. A multi-threading action could for example be an action that is intended to increase one or both of the size and diversity of the opportunity team.

As indicated in 410, multi-threading, recommendation module 118 may perform an analysis that is based on the current data available in respect of the target opportunity 194(j) and the Account 190. In some examples, one or more a predefined recommendation model(s) 408A that can be rules-based, machine learning based, or a combination thereof, is used to generate assessments. By way of example, recommendation model 410A may be configured to receive as inputs: (i) data from relationship database 122 identifying the individuals that are on the Account Team and the Enterprise Team (collectively the opportunity team) for the target opportunity 194(j); and (ii) data from database 122 identifying, as candidate team members, enterprise users 180 and account contacts 190 that have existing relationships but are not currently included on the opportunity team. For example, this data could be based on user-contact pairs that are identified in user-contact relationship data 134 and have current User-Contact Relationship Scores above a defined threshold, in respect of users and contacts that are not included in the current opportunity team. In some examples, recommendation model 410A is configured to iteratively calculate possible multi-thread scores for opportunity 194(j) based on changes to the opportunity team by adding one or more of these candidate team members in order to determine what additions would optimize the opportunity multi-thread score. A team change recommendation 410B (e.g., “Add Bob M to Enterprise Team”) to add the one or more candidate team members to the opportunity team could then be generated and communicated to a UE 104 for output to a user 182 through a user interface generated by CRM support client 108.

In some examples, recommendation model 410A may simply be configured to recommend the user 182 who has the strongest user-account relationship score to the Enterprise Team if that user is not already on the opportunity team, and/or to recommend the contact 192 who has the strongest contact-enterprise relationship score to the Account Team if that contact user is not already on the opportunity team.

As indicated in 412, multi-threading, recommendation module 118 may perform a further analysis that is based on the data available in respect of one or more of the K-matched historic opportunities 194. In some examples, one or more predefined recommendation model(s) 412A that can be rules-based, machine learning based, or a combination thereof, is used to generate assessments. By way of example, recommendation model 412A may be configured to receive as inputs: (i) data from relationship database 122 identifying the composition of Account Team and the Enterprise Team (collectively the opportunity team) including the departments of the individuals involved and the title scores of the individuals and for the target opportunity 194(j); and (ii) data from database 122 identifying, the composition of the opportunity teams involved in the K-matched historic opportunities 194. The team composition data may in some examples be specific to the teams that existed when the historic opportunities were at the same stage/milestone achievement level as the current target opportunity. In some examples, recommendation model 412A is configured to compare the diversity of such historic opportunity teams (e.g., departments involved and the title scores of people in those departments) and based on such comparisons make a team change recommendation 412 (e.g., “Add a senior IT person from Account”). In some examples, a specific person may be recommend to fill a position/title score requirement based on a match in contact data 130, in which case recommendation 412B could be: (e.g., “Add a senior IT person from Account, such as (1) Ken Smith, who has a title score of X, whose strongest relationship is with Bob M; and/or (2) Kelly Mack who has a title score of X, whose strongest relationship with Sam T.” In some examples, recommendation model 412A is configured to iteratively calculate possible multi-thread scores for opportunity 194(j) based on changes to the opportunity team by adding one or more of these recommended candidate team members in order to determine what additions would optimize the opportunity multi-thread score. In such cases, recommendation 412B could be: (e.g., “Add a senior IT person from Account, such as (1) Ken Smith, who has a title score of X, whose strongest relationship is with us is Bob M, to increase Multi-Thread score by 20%”)

In some examples, where a contact 192 is recommended for addition to the opportunity team by either recommendation model 410A or 412B, the Multi-threading recommendation module may be configured to determine, from user-contact relationship data 134, the enterprise user 182 that has the strongest user-contact relationship score with that contact 192 and further recommend that that user be used to make the approach to recruit the contact for possible addition to the opportunity team. For example, the generated recommendation 410B could be “Susan G. from Account should be added to Account team for the opportunity. Bob. M has the strongest relationship with her, so he should make the approach”.

In some examples, if a user 182 does not like or accept a team change recommendation 410A or 412B, the CRM client 108 provides an interface through which the user 182 can reject the recommendation and request that the recommendation model 410A or 412A be rerun with the prior recommendation be omitted from the set of possible recommendations. For example, the recommendation may be “add user Bob M.”, but this is not possible as Bob M. is known to be busy and accordingly, a user of UE 104 requests that the recommendation model 410A be rerun without Bob M. being included in the group of candidate team members, and a new recommendation 410B being generated.

As noted above, the models used in the method and systems described herein may be rules-based or machine learning based, or a combination thereof. Machine learning technique can include, but are not limited to techniques that apply principal component analysis, singular value recomposition, or multi-dimensional scaling. In some examples machine learning models can include artificial neuron network (ANN) computational models that are trained based on historical opportunity data. ANNs are considered nonlinear statistical data modeling tools where the complex relationships between inputs and outputs are modeled or patterns are found. ANNs are deep learning models capable of pattern recognition and machine learning. In some examples, the historical opportunity training data may include anonymized data from other accounts, thus enabling experiences and knowledge from sales activities with other accounts to be incorporated into the models.

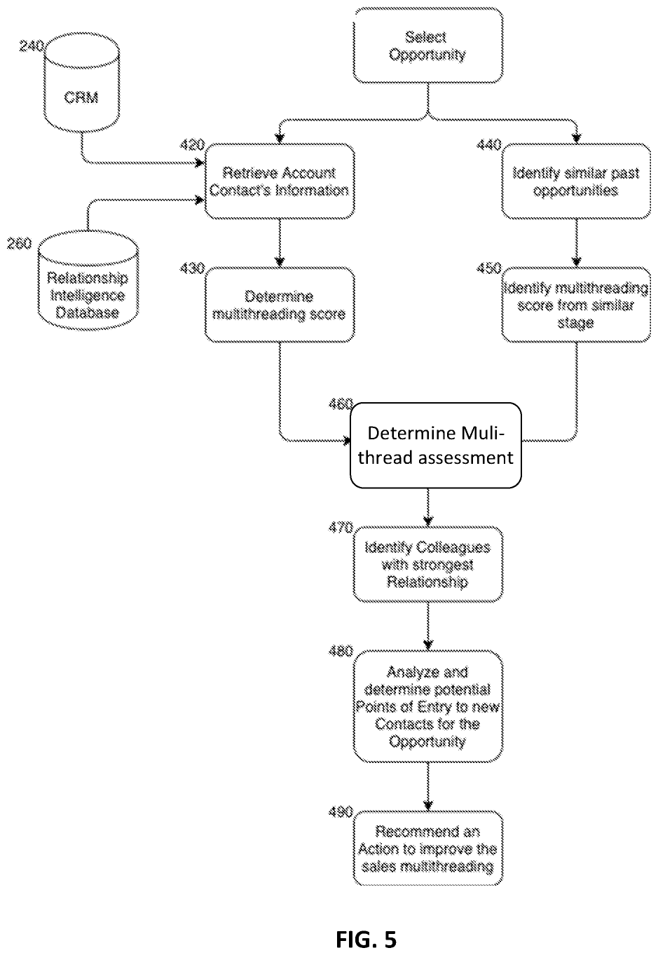

The multi-threading analysis can be performed using a different order and different data sources than discussed above. In this regard, FIG. 5 illustrates an alternative process that may be performed by multi-threading recommendation module operating in the environment of FIG. 1.

As illustrated in step 419 of FIG. 5, an opportunity (e.g., target opportunity 194(j)) to be reviewed will be selected. This selection may be a manual selection, or the selection process may be performed at prescheduled times (such as but not limited to a weekly batch of all open opportunities).

In the embodiment of FIG. 5, the multithreading module 118 will, as illustrated in step 420, retrieve all contacts 192 associated to the account 190 for the selected opportunity 194(j). This information will include, but not be limited to, contact name, contact title, contact department, contact company, relationships with other enterprise employees 182, and relationship scores.

The multithreading module would then determine a multithreading score for the opportunity. This score would be a numerical representation of the breadth and depth of contacts and relationships in the current opportunity. The score is determined by analyzing the contacts' titles, departments, and relationships with the enterprise employees involved in the opportunity. The scoring is weighted such that additional contacts from the same department and title would not significantly increase the score.

The pattern generation module 121 would determine a pattern for the selected opportunity, as represented by blocks 440 and 450. The pattern generation module 118a would utilize this pattern to identify a matching pattern from completed opportunities. Once a matching pattern has been identified, the multithreading module 118 would identify the multithreading score from the matching opportunity at the stage of the sales process that the current opportunity is in.

As represented by block 460, the multithreading module 118 will determine a multi-thread assessment for the select opportunity. This multi-thread assessment is determined by analyzing the score identified in block 430 and the score identified in block 450. The multi-thread assessment will account for the stage of the opportunity as an opportunity that was a recently qualified sales lead should have a lower score than an opportunity at a later sales phase. An overall status of the multithreading score would be identified (such as but not limited to, Green, Yellow, or Red multi-thread assessment).

As illustrated in blocks 470 and 480, the multithreading module 118 would identify the enterprise users 182 that are not already involved in the opportunity, with the strongest relationship scores to account contacts 192. The multithreading module 118 would utilize a machine learning model to analyze the possible additions to the sales team that would best increase the multithreading score. The present embodiment would include a comparison to the past opportunities identified in block 440.

The multithreading module 118 will identify a recommended action, represented by step 490, that would increase the multithreading score of the opportunity. These recommended actions may be, but not limited to: (i) Adding a specific enterprise employee 182 to the sales team; (ii) Task a sales team member to reach out to an existing account contact 192 not currently involved in the opportunity; (iii) Task a sales team member with improving the relationship score with a contact 192 currently involved in the opportunity; and/or (iv) Task the sales team with adding a new account contact 192 from a different department or title (specified in the recommendation).

The multithreading module 118 would highlight an area of weakness with the recommended actions above. The recommended actions would be focused on increasing the breadth of multithreading (through adding additional contact departments to the opportunity) and the depth of multithreading (through adding additional contacts with increasing seniority or title score).

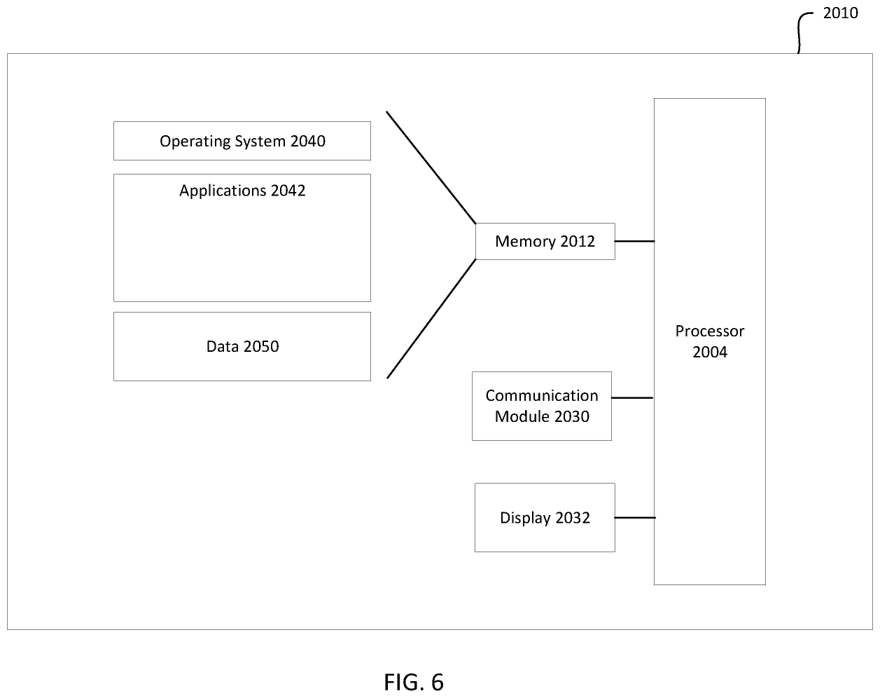

Referring to FIG. 6, an example embodiment of a computer system 2010 for implementing one or more of the modules, systems and agents included in enterprise network 110, CRM system 200, and CRM support system 120 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 2042 executed by the processor 2004 are also stored in the persistent memory. The applications 2042 can include software instructions for implementing the systems, methods, agents and modules described above (including for example lead qualification module 118).

The system 2010 is configured to store data that may include data objects 124 in the case of CRM support system 120 and the campaign data of campaign database 300 in the case of campaign management system 290. The system 2010 may include an interactive display 2032 and other human I/O interfaces in the case of UE device 104.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method for analyzing data in respect of one or more opportunities that exist between an enterprise entity that has a plurality of associated users and an account entity that has a plurality of associated contacts, the method comprising:
receiving, from one or more electronic storage devices:
(A) account team member data that: (i) identifies a group of contacts that have been identified as participating in a target opportunity; (ii) includes title scores for at least some of the contacts included in the group of contacts, the title sore for each contact being indicative of a position of the contact in a hierarchy of the account entity; (iii) includes department indicators for at least some of the contacts included in the group of contacts, wherein the department indicator for each contact indicates a department of the account entity that the contact is a member of; and (iv) relationship scores for at least some of the contacts included in the group of contacts, the relationship score for each contact indicating a strength of a relationship between the contact and the enterprise entity; and
(B) enterprise team member data that: identifies a group of users that have been identified as participating in the target opportunity,
and
processing the account team member data and the enterprise team member data using a predefined model to assign a current multi-thread score to the target opportunity, the current multi-thread score being indicative of a suitability of the combined membership of the group of contacts and the group of users.

2. The method of claim 1 wherein the enterprise team member data further includes: title scores for at least some of the users included in the group of users, the title score for each user being indicative of a position of the user in a hierarchy of the enterprise entity; (iii) includes a department indicator for at least some of the users included in the group of users, wherein the department indicator for each user indicates a department of the enterprise entity that the user is a member of; and (iv) a relationship score for at least some of the users included in the group of users contacts, the relationship score for each user indicating a strength of a relationship between the user and the account entity.

3. The method of claim 2 wherein the current multi-thread score is assigned based in part on a diversity of: the title scores for the contacts included in the group of contacts; the department indicators for the contacts included in the group of contacts; the title scores for the users included in the group of users; and the department indicators for the users included in the group of users.

4. The method of claim 2 wherein the predefined model is preconfigured to apply different weights to different features included in the account team data and the enterprise team data when assigning the current multi-thread score.

5. The method of claim 1 wherein the relationship scores are determined based on tracked records of communications activities that have occurred between the contacts in the group of contacts and users associated with the enterprise entity.

6. The method of claim 1 comprising:
determining at least one individual who is either a user associated with the enterprise entity and is not included in the group of users or who is a contact associated with the account entity but is not included in the group of contacts;
determining if the addition of the individual to the group of users or to the group of contacts can improve the assigned current multi-thread score; and
generating an output recommending that the individual be added either to the group of users or to the group of contacts based on determining that the addition of the individual would improve the assigned current multi-thread score.

7. The method of claim 1 comprising:
identifying a set that includes one or more historic opportunities that are similar to the target opportunity based on a comparison of: (i) pattern data about the historic opportunities stored in the one or more electronic storage devices, and (ii) pattern data determined in respect of the target opportunity;
determining, based on comparison of the multi-thread scores for opportunities in the set of historic opportunities with the current multi-thread score for the target opportunity, a classification of the multi-thread score for the target opportunity; and
generating an output indicating the classification.

8. The method of claim 7 comprising:
determining if the current multi-thread score for the target opportunity can be improved by adding a contact having one or both of a particular title score and a particular department score to the group of contacts based on a comparison of one or both of: (i) the title scores the contacts included in the group of contacts for the target opportunity with title scores of contacts that have participated in the set of historic opportunities, and (ii) the department indicators for the contacts included in the group of contacts for the target opportunity with department indicators for contacts that have participated in the set of historic opportunities; and
generating an output recommending that a contact having one or both of the particular title score and the particular department score individual be added either to the group of contacts based on determining that the addition would be improved by adding the contact.

9. The method of claim 7 wherein the pattern data about historic opportunities comprises a feature vector of static attributes in respect of each of the historic opportunities in the set of historic opportunities and the pattern data determined in respect of the target opportunity comprises a feature vector of the static attributes for the target opportunity, wherein the static attributes include attributes that indicate one or more of: a size of the opportunity; and a product or service that the opportunity relates to.

10. The method of claim 7 wherein the multi-thread scores for opportunities in the set of historic opportunities correspond to when the opportunities were at the same stage of an opportunity cycle as the target opportunity.

11. A system comprising one or more computer systems and one or more storage devices storing instructions that when executed by the one or more computers cause the one or more computers to implement an multi-threading analysis method for analyzing data in respect of one or more opportunities that exist between an enterprise entity that has a plurality of associated users and an account entity that has a plurality of associated contacts, the method comprising:
receiving, from one or more storage devices:
(A) account team member data that: (i) identifies a group of contacts that have been identified as participating in a target opportunity; (ii) includes title scores for at least some of the contacts included in the group of contacts, the title sore for each contact being indicative of a position of the contact in a hierarchy of the account entity; (iii) includes department indicators for at least some of the contacts included in the group of contacts, wherein the department indicator for each contact indicates a department of the account entity that the contact is a member of; and (iv) relationship scores for at least some of the contacts included in the group of contacts, the relationship score for each contact indicating a strength of a relationship between the contact and the enterprise entity; and
(B) enterprise team member data that: identifies a group of users that have been identified as participating in the target opportunity,
and
processing the account team member data and the enterprise team member data using a predefined model to assign a current multi-thread score to the target opportunity, the current multi-thread score being indicative of a suitability of the combined membership of the group of contacts and the group of users.

12. The system of claim 11 wherein the enterprise team member data further includes: title scores for at least some of the users included in the group of users, the title score for each user being indicative of a position of the user in a hierarchy of the enterprise entity; (iii) includes a department indicator for at least some of the users included in the group of users, wherein the department indicator for each user indicates a department of the enterprise entity that the user is a member of; and (iv) a relationship score for at least some of the users included in the group of users contacts, the relationship score for each user indicating a strength of a relationship between the user and the account entity.

13. The system of claim 12 wherein the current multi-thread score is assigned based in part on a diversity of: the title scores for the contacts included in the group of contacts; the department indicators for the contacts included in the group of contacts; the title scores for the users included in the group of users; and the department indicators for the users included in the group of users.

14. The system of claim 12 wherein the predefined model is preconfigured to apply different weights to different features included in the account team data and the enterprise team data when assigning the current multi-thread score.

15. The system of claim 11 wherein the relationship scores are determined based on tracked records of communications activities that have occurred between the contacts in the group of contacts and users associated with the enterprise entity.

16. The system of claim 11 wherein the method further comprises:
determining at least one individual who is either a user associated with the enterprise entity and is not included in the group of users or who is a contact associated with the account entity but is not included in the group of contacts;
determining if the addition of the individual to the group of users or to the group of contacts can improve the assigned current multi-thread score; and
generating an output recommending that the individual be added either to the group of users or to the group of contacts based on determining that the addition of the individual would improve the assigned current multi-thread score.

17. The system of claim 11, the method further comprising:
identifying a set that includes one or more historic opportunities that are similar to the target opportunity based on a comparison of: (i) pattern data about the historic opportunities stored in the one or more electronic storage devices, and (ii) pattern data determined in respect of the target opportunity;
determining, based on comparison of the multi-thread scores for opportunities in the set of historic opportunities with the current multi-thread score for the target opportunity, a classification of the multi-thread score for the target opportunity; and
generating an output indicating the classification.

18. The system of claim 17, the method further comprising:
determining if the current multi-thread score for the target opportunity can be improved by adding a contact having one or both of a particular title score and a particular department score to the group of contacts based on a comparison of one or both of: (i) the title scores the contacts included in the group of contacts for the target opportunity with title scores of contacts that have participated in the set of historic opportunities, and (ii) the department indicators for the contacts included in the group of contacts for the target opportunity with department indicators for contacts that have participated in the set of historic opportunities; and
generating an output recommending that a contact having one or both of the particular title score and the particular department score individual be added either to the group of contacts based on determining that the addition would be improved by adding the contact.

19. The system of claim 17 wherein the pattern data about historic opportunities comprises a feature vector of static attributes in respect of each of the historic opportunities in the set of historic opportunities and the pattern data determined in respect of the target opportunity comprises a feature vector of the static attributes for the target opportunity, wherein the static attributes include attributes that indicate one or more of: a size of the opportunity; and a product or service that the opportunity relates to.

20. The system of claim 17 wherein the one or more computers are configured by the instructions to implement a machine learning based model as the predefined model.
